(19) United States
(12) Patent Application Publication
(10) Pub. No.: US 2015/0024934 A1
(43) Pub. Date: Jan. 22, 2015

(54) CONTROLLING CHARCOAL ROT WITH FLUTRIAFOL

(71) Applicant: CHEMINOVA A/S, Harboore (DK)

(72) Inventors: James BARRENTINE, Fayetteville, AR (US); Andy BAILEY, Westbridge (GB)

(73) Assignee: CHEMINOVA A/S, Harboore (DK)

(21) Appl. No.: 14/328,844

(22) Filed: Jul. 11, 2014

(30) Foreign Application Priority Data
Jul. 17, 2013 (DK) PA 2013 70406

(51) Int. Cl. A01N 43/653; C05G 3/02

(52) U.S. Cl. CPC A01N 43/653; C05G 3/02
USPC 504/100; 514/383; 504/101; 504/358; 548/267.8

(57) ABSTRACT

This invention relates to the use of flutriafol for controlling or preventing pathogenic damage caused by the fungi Macrophomina phaseolina in a plant propagation material, a plant, part of a plant and/or plant organ that grow or grows at a later point in time. The use comprises applying a composition of flutriafol on the plant, part of the plant, plant organ, plant propagation material or a surrounding area.

### FIELD OF THE INVENTION

The present invention relates to the use of the compound flutriafol for protecting plants and plant propagation material from charcoal rot, which leads to higher yields, better grade, and improved harvest efficiency.

### BACKGROUND

A severe threat to more than 500 cultivated and wild plants, for example alfalfa, peas, rice, maize, cucurbits, tomatoes, sorghum, soybean, peanuts, sunflower, cotton or corn, is a root disease commonly known as charcoal rot. The causative agent of charcoal rot is the fungus Macrophomina phaseolina. The fungus was first observed in 1926 in Sri Lanka, where it infected sunflowers. M. phaseolina is reported to be a soil, seed and stubble borne pathogen. However, it is primarily a root inhibiting fungus. M. phaseolina is widespread throughout tropical and subtropical countries, but the disease can also develop in temperate countries when hot dry conditions exist.

Seedling infections by charcoal rot results in a discoloration at the soil line. Seedlings may die if hot, dry conditions exist, or they may survive in wet weather with disease symptoms reappearing during hot dry weather when unfavourable environmental conditions stress the plant. In older plants, a light brown discoloration of internal tissue occurs and the plant turns yellow and mature very early. Below the epidermis, at the soil line, small black bodies appear, giving the tissue a grayish-black appearance. On dead plants whose diseased tissues are dry, the fungus produces numerous microsclerotia, which are tiny black fungal structures similar to charcoal dust. M. phaseolina survives and overwinters as small, black microsclerotia in the soil and infested plant debris. When growing roots of a susceptible plant contacts a microsclerotium in the soil, this resting state germinates, and the fungus grows over the surface of the root and penetrates between the epidermal cells into the root cortex. From there the fungus advances through the cortex and the inner bark into and up the root. The gradual destruction of the root system causes the seedlings to become stunted and chlorotic, and the plant dies as a result.

The ability to control charcoal rot is very limited. M. phaseolina can survive in the soil for at least two years. The best defence against this fungus is planting rotating crops which are not susceptible to charcoal rot. Also field management is very important such that a reduction or complete avoidance of drought stress to plants is assured. Other methods of defence are development of crop cultivars with resistant strains. However, this method has not been possible in several crops, such as sunflower. Previously, chemical control has not been successful due to high level of variation in the fungus, soil borne habitat, and good survival ability of the sclerotia.

A successful method for controlling the fungus M. phaseolina (charcoal rot) is therefore highly needed.

### SUMMARY OF THE INVENTION

It has now surprisingly and unexpectedly been found that the fungicidal active compound flutriafol shows a remarkably prolonged effect in the control of charcoal rot disease on plants when applied in an effective amount on the plant, part of the plant, plant organ, plant propagation material or a surrounding area thereof as part of a composition comprising flutriafol.

Accordingly, this invention relates to the use of flutriafol for controlling or preventing pathogenic damage caused by the fungi Macrophomina phaseolina in a plant propagation material, a plant, part of a plant and/or plant organ that grow or grows at a later point in time, by applying a composition comprising flutriafol on the plant, part of the plant, plant organ, plant propagation material or a surrounding area thereof.

### DESCRIPTION OF THE INVENTION

One aspect of the invention relates to the use of flutriafol for protecting a plant from charcoal rot disease (Macrophomina phaseolina). The use comprises applying a composition comprising an effective amount of flutriafol on the plant, part of the plant, plant organ, plant propagation material or a surrounding area thereof.

A second aspect of the invention relates to a method of controlling or preventing pathogenic damage caused by the fungi M. phaseolina in a plant propagation material, a plant, part of a plant and/or plant organ that grow or grows at a later point in time, which comprises applying on the plant, part of the plant, plant organ, plant propagation material or a surrounding area thereof a composition comprising flutriafol.

Flutriafol, a well-known fungicidally active compound, is a member of the triazole group of fungicides. The IUPAC name of flutriafol is (RS)-2,4′-difluoro-α-(1H-1,2,4-triazol-1-ylmethyl)benzhydryl alcohol. The chemical structure of the compound is reproduced below:

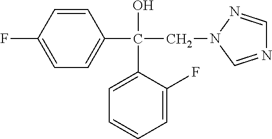 [SMILES: OC(Cn1cncn1)(c1ccc(F)cc1)c1ccccc1F]

Flutriafol is sold commercially as a fungicide by Cheminova under the trade names TOPGUARD®, Impact® and Vincit®.

Flutriafol is systemic with long lasting residual activity and can therefore effectively be used to protect plants, at any point during the growth season, from the fungus M. phaseolina.

Without being bound by theory, flutriafol has a dual effect against charcoal rot due to both its persistence in the soil providing a zone of control around the seed, developing root and developing seedling by contact action with the fungi but also as the root develops flutriafol is efficiently taken up by the developing root system both protecting the roots and young developing seedling from infection. If the soil and temperature conditions are conducive, the first 3-4 weeks of the life of a plant is a critical time to prevent the disease from entering the plant. The flutriafol protective effect will endure throughout that critical period of infection from seedling to plant. In addition the systemicity will allow flutriafol to move further up the vascular system of the plant, potentially protecting it from any proliferation of disease in the growing stem. Flutriafol may also be applied as foliar application (e.g. sprayed directly on the foliage).

As used herein, a plant includes all known plants susceptible of being infected by charcoal rot and all known varieties, including genetically modified plants. The term “plant propagation material” is understood to denote all the generative parts of the plant, such as seeds, which can be used for the multiplication of the latter and vegetative plant materials such as cuttings and tubers (for example, potatoes). Accordingly, as used herein, part of a plant includes plant propagation material. There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected before/at transplantation by a total or partial treatment by immersion.
Parts of plant and plant organs that grow or grows at later point in time are any sections of a plant that develop from a plant propagation material, such as a seed.
Parts of plant, plant organs, and plants can also benefit from the protection achieved by the application of flutriafol onto the plant propagation material. In an embodiment, certain parts of a plant and certain plant organs that grow or grows at later point in time can also be considered as plant propagation material, which can themselves be applied (or treated) with flutriafol; and consequently, the plant, further parts of the plant and further plant organs that develop from the treated parts of plant and treated plant organs can also benefit from the pathogenic and/or pest damage protection achieved by the application of flutriafol onto the certain parts of plant and certain plant organs. A plant seed includes all known plants seeds susceptible of being infected by charcoal rot and all known seed varieties/hybrids, including genetically modified seeds.

Using the flutriafol composition, it is possible to control charcoal rot that occur in plants, especially in cultivated plants and ornamentals, in horticulture and in forestry, or in parts of such plants such as fruit, blossoms, leaves, stems, tubers or roots, while in some cases parts of plants that grow or grows later can also be protected against the pathogenic fungus.

The flutriafol composition can be used with advantage for controlling charcoal rot in strawberries, sugar beets, pepper, ornamentals, hops, cereals, sweet corn, maize, grasses, sorghum, rice, and tobacco; Brassicas such as canola, broccoli, brussels sprouts, cauliflower, cabbage, rape, mustard; other Crucifers such as beets, radish, carrots; Cucurbitaceae such as squash, cucumber, marrows, melons; Leguminosae such as mung beans, beans, lentils, peas, soybeans, groundnuts, chick peas, cowpea, lupin, clover, white clover, alfalfa; Solanaceae such as potatoes, tomatoes, paprika, bell pepper, chili, aubergine; Citrus such as oranges, lemons, grapefruit, mandarins, kumquats; Fibrous crops such as cotton, flax, hemp and jute; Cane fruit such as raspberries, blackberries; Asteraceae such as sunflower. Preferably, the plant is selected from the families of Brassicaceae, Cucurbitaceae, Leguminosae, Asteraceae, and Solanaceae and the crops sugar beets, cotton, pepper, tobacco and strawberry. Most preferably, the crops are selected among soybeans, sorghum, sunflower, corn, beans, cucurbits, strawberry, pepper, tomato, alfalfa, white clover, potato, cotton, tobacco, peanut, sugar beet, canola, mung bean, cowpea, chickpea, lentils and lupines.

The use of flutriafol as well as the application methods according to the invention for the protection of plants against charcoal rot include applying the flutriafol composition as foliar application or application in the soil in close proximity to the seed and roots of the plant. The use of flutriafol and the application methods according to the invention for the protection of plant propagation material against attack by charcoal rot are characterized in that, for example, the composition are applied in such a manner that it is applied in close spatial proximity to, or spatially together with, planting or sowing the plant propagation material at the site of planting or sowing. Application of the composition in close spatial proximity to the site of planting or sowing takes place preferably when planting or sowing the plant propagation material, by applying the compositions by soil application directly to the site where the plant propagation material has been planted or sown, for example preferably when sowing into the seed furrow, or to a closely delimited area around the site of planting or sowing the plant propagation material. In addition, flutriafol will create a zone of protection in the soil, which controls the fungus in the soil, but also the roots and stems, when contacted with the soil containing the composition, absorb the composition, and then distribute the composition throughout the plant through known means. Application of such compositions, which takes place spatially together with planting or applying the plant propagation material to the site of planting or sowing is to be understood as meaning that plant propagation material which has been pretreated with these compositions is planted or sown at the site of planting or sowing, it being possible, depending on the intended aims and prevailing circumstances, for the pretreatment of the plant propagation material to be affected for example by spraying, atomizing, dusting or scattering the compositions over the plant propagation material or brushing or pouring the compositions over the plant propagation material or, in the event of seed, in particular also by dressing the seed. When carrying out seed dressing, i.e. dry seed, wet seed-dressing, liquid seed-dressing or slurry dressing, flutriafol is added to the seed prior to sowing in a seed-dressing apparatus and the composition is distributed uniformly over the seed, for example by stirring the contents of the seed-dressing apparatus and/or by rotating and/or shaking the entire seed-dressing apparatus. Particular embodiments of such a seed-dressing treatment comprise, for example, immersing the seed in a liquid composition, coating the seed with a solid composition (seed coating) or by achieving penetration of the active ingredient into the seed by adding the composition to the water used for pre-soaking the seed (seed soaking). For a general discussion of techniques used to apply fungicides to seeds, see “Seed Treatment,” 2d ed., (1986), edited by K. A Jeffs (chapter 9), herein incorporated by reference in its entirety.

Preferred application methods are
(A) Seed treatment, wherein the seed is treated with the flutriafol composition prior to planting the seed;
(B) Preemergence or postemergence application.
   i. Preemergence refers to application of the flutriafol composition before the plants have emerged from the soil.
   ii. Postemergence refers to application of the flutriafol composition after the plant have emerged from the soil. For example the flutriafol composition is sprayed directly at the stem base, leaves, or soil interface of the plants;
(C) In-furrow application.
   i. T-band application wherein the flutriafol composition is added before the furrow is closed, but after the plant propagation material is added to the opened furrow; or after the furrow has been closed.
   ii. Modified in-furrow application wherein a plant propagation material is placed in an open furrow and the flutriafol composition is added such that it surrounds the plant propagation material, but minimizes the contact with the plant propagation material;
   iii. granular application, either on fertilizer or a solid carrier applied in-furrow or potentially on side of furrow;
(D) Band spray application, wherein the flutriafol composition is sprayed onto the soil before
   i. planting the plant propagation material; or
   ii. planting the plant propagation material, and also incorporated the flutriafol composition into the soil;
(E) Irrigation either by
   i. drip
   ii. trickle on demand systems; or
   iii. higher volume chemigation systems;
(F) At transplanting by
   i. dipping, wherein transplants is dipped into the flutriafol composition prior to transplanting
   ii. Drenching, wherein transplants are drenched with a flutriafol composition after transplanting.

The invention also relates to a plant propagation material, a plant, part of a plant and/or plant organ that has been treated with flutriafol for the protection against the fungi M. phaseolina. The plant propagation material, a plant, part of a plant and/or plant organ can be treated in accordance with any of the uses and applications methods described herein using any composition comprising flutriafol, e.g. as those described herein.

As used herein, an amount of the composition effective to provide protection to the plant propagation material or the plant against damage caused by fungi is the lowest amount of flutriafol that will provide such protection. Accordingly, an effective amount of flutriafol, i.e. a fungicidal effective amount, is an amount sufficient to provide adequate disease control. An adequate amount is not easily defined, since it depends on various conditions, such as method of application, the type or size of plant or plant propagation material be protected, and climate condition at time of application. However, as general guidelines the following may be applied. When applied to the soil from which the plant propagation material or the plant grows, the flutriafol composition may be applied in an amount ranging from about 25 to about 800 gram flutriafol per hectare (g/ha), preferably from about 50 to about 600 g/ha, more preferred from about 100 to 400 g/ha and even more preferred from about 125 to 300 g/ha. When applied to the propagation material, the flutriafol composition may be applied in an amount ranging from about 1 to about 50 grams flutriafol per 100 kilograms of propagation material. When applied as a dip treatment of transplants, the flutriafol composition may be diluted as appropriate to provide a final concentration of flutriafol in solution ranging from about 0.001 to about 1% w/v, preferably from 0.001 to about 0.01% w/v. When applied as foliar application, the flutriafol composition may be applied in an amount of 25 or more, 50 or more, 100 gram flutriafol per hectare or more; or the flutriafol composition may be applied in an amount of 800 or less, 700 or less, 600 gram flutriafol per hectare or less; preferably in an amount ranging from about 25 to about 800 gram flutriafol per hectare of cultivation area.

The composition comprising flutriafol may also contain one or more fertilizers or nutrients to promote growth of the plant propagation material or plant once planted. The fertilizers may be mixed or incorporated into the composition comprising flutriafol, used with the flutriafol composition as a separate component, or used independently of the flutriafol composition in a separate application. Suitable fertilizers include organic and inorganic nitrogen-comprising compounds such as urea, urea-formaldehyde condensation products, amino acids, ammonium salts and nitrates; potassium salts (preferably chlorides, sulphates, nitrates); and phosphoric acid and/or salts of phosphoric acids (preferably potassium salts and ammonium salts). The fertilizers may also contain salts of micronutrients (preferably manganese, magnesium, iron, boron, copper, zinc, molybdenum and cobalt) and phytohormones (e.g. vitamin B1 and indole-III-acetic acid). The amount of fertilizer used is generally dependent on the crop, soil type, nutritional requirement, and crop rotation. The use of fertilizers in the composition may also serve to impregnate/absorb the flutriafol to create solid fertilizer carrier material, e.g. fertilizer granules comprising the flutriafol. Generally, when used in this manner, the fertilizer compositions comprising the flutriafol should contain from 0.0001 to 95% by weight flutriafol, preferably 0.1 to 90%.

The flutriafol composition may optionally contain additional fungicides, herbicides, bactericides, inoculants, acaricides, nematicides and/or insecticides. Like the fertilizers, the additional fungicides, bactericides, acaricides, nematicides, and insecticides may be mixed or incorporated into the composition comprising flutriafol, used with the flutriafol composition as a separate component, or used independently of the flutriafol composition in a separate application on the soil. Suitable examples of additional fungicides are e.g.:
A) azoles, in particular: azaconazole, bitertanol, bromuconazole, cyproconazole, difenoconazole, diniconazole, enilconazole, epoxiconazole, fluquinconazole, fenbuconazole, flusilazole, hexaconazole, imibenconazole, ipconazole, metconazole, myclobutanil, oxpoconazole, penconazole, propiconazole, prothioconazole, pyrisoxazole, simeconazole, triadimefon, triadimenol, tebuconazole, tetraconazole, triticonazole; prochloraz, pefurazoate, imazalil, triflumizole, cyazofamid; benomyl, carbendazim, thiabendazole, fuberidazole, ethaboxam, etridiazole, hymexazole;
B) strobilurins, in particular: azoxystrobin, benzothiostrobin, coumethoxystrobin, coumoxystrobin, enoxastrobin, dimoxystrobin, fenaminstrobin, flufenoxystrobin, enestroburin, fluoxastrobin, kresoxim-methyl, mandestrobin, metominostrobin, orysastrobin, picoxystrobin, pyraclostrobin, pyriminostrobin, pyrametostrobin, trifloxystrobin, triclopyricarb, pyraoxystrobin, fenamidone, famoxadone, or pyribencarb;
C) carboxamides, in particular: carboxin, benalaxyl, benodanil, boscalid, fenfuram, fenhexamid, fenpyrazamine, flutolanil, furalaxyl, furametpyr, isofetamid, isotranil, kiralaxyl, mepronil, metalaxyl, mefenoxam, ofurace, oxadixyl, oxycarboxin, penthiopyrad, pyrimorph, thifluzamide, tiadinil, bixafen, dimethomorph, flumorph, flumetover, fluopicolide (picobenzamid), zoxamide, carpropamid, diclocymet, mandipropamid, isopyrazam, fluxapyroxad, sedaxane, penflufen, fluopyram;
D) heterocylic compounds, in particular: benzovindiflupyr, isofetamid, fluazinam, pyrifenox, bupirimate, cyprodinil, fenarimol, ferimzone, mepanipyrim, nuarimol, pyrimethanil, triforine, fenpiclonil, fludioxonil, aldimorph, chloozolinate, dimethirimol, dodemorph, ethirimol, fenpropimorph, tridemorph, fenpropidin, iprodione, piperalin. procymidone, vinclozolin, famoxadone, fenamidone, octhilinone, probenazole, pyrisoxazole, amisulbrom, anilazine, diclomezine, pyroquilon, proquinazid, tricyclazole, acibenzolar-S-methyl, captafol, captan, dazomet, folpet, fenoxanil, quinoxyfen;
E) carbamates, in particular: mancozeb, maneb, metam, metiram, ferbam, propineb, thiram, zineb, ziram, benthiavalicarb, diethofencarb, iodocarb, iprovalicarb, flubenthiavalicarb, methasulfocarb, propamocarb, prothiocarb, pyributicarb, valifenalate; and
F) other active compounds, selected from guanidines: dodine, iminoctadine, guazatine, antibiotics: blasticidin-S, kasugamycin, streptomycin, oxytetracycline, polyoxin, validamycin; nitrophenyl derivates: binapacryl, dinocap, dinobuton, meptyldinocap; sulfur-containing heterocyclyl compounds: dithianon, isoprothiolane; organometal compounds: fentin salts, such as fentin-acetate, chloride or hydroxide; organophosphorus compounds: edifenphos, iprobenfos, fosetyl, fosetyl-AL, phosphorous acid and its salts, pyrazophos, tolclofos-methyl; organochlorine compounds: biphenyl, chloroneb, dicloran, chlorothalonil, dichlofluanid, flusulfamide, hexachlorobenzene, phthalide, pencycuron, quintozene, tecnazene, thiophanate-methyl, tolylfluanid; inorganic active compounds: Bordeaux mixture, copper acetate, copper hydroxide, copper oxychloride, basic copper sulfate, sulfur; others: cyflufenamid, cymoxanil, dimethirimol, ethirimol, metrafenone, flutianil, pyriofenone, bupirimate, oxathiapiprolin, benzovindiflupyr and spiroxamine;
G) Biological fungicides, in particular: Bacillus spp.: B. subtilis, B amyloliquefaciens; plant extracts: Melaleuca alternifolia.
Suitable examples of insecticides, nematicides and acaricides are e.g.: abamectin, acequinocyl, acephate, acetamiprid, acrinathrin, afidopyraben, alanycarb, albendazole, aldicarb, allethrin, alpha-cypermethrin, aluminium phosphide, amitraz, azadirachtin, azamethiphos, azinphos-ethyl, azocyclotin, Bacillus firmus, Bacillus sphaericus, Bacillusthuringiensis (including susp.), bendiocarb, benfuracarb, bensultap, benzoximate, bephenium, betacyfluthrin, beta-cypermethrin, bifenazate, bifenthrin, bioallethrin, bioallethrin S-cyclopentenyl isomer, bioresmethrin, bistrifluron, borax, BPMC, brofenprox, bromophos, bromopropylate, brotianide, bufencarb, buprofezin, butamisole, butocarboxim, butoxycarboxim, butylpyridaben, cadusafos, calcium phosphide, cambendazole, carbaryl, carbofuran, carbophenothion, carbosulfan, cartap hydrochloride, chinomethionat, chloethocarb, chlorantraniliprole, chlordane, chlorfenapyr, chloroethoxyfos, chlorofenvinphos, chlorofluazuron, chloromephos, chloropicrin, chlorpyrifos, chlorpyrifos-methyl, chromafenozide, cis-resmethrin, clocythrin, clofentezine, clorsulon, closantel, clothianidin, cryolite, coumaphos, cyanide, cyantraniliprole, cyanophos, cyclaniliprole, cycloprothrin, cyenopyrafen, cyflumetofen, cyfluthrin, cyhalothrin, cyhexatin, cypermethrin, cyphenothrin, cyromazine, d-cis-trans allethrin, deltamethrin, DDT, demeton-S-methyl, diafenthiuron, diamphenethide, dibromosalan, dichlorophen, 1,3-dichloroprene, difenthiuron, diazinon, dichlofenthion, dichlorvos, dicliphos, dicofol, dicrotophos, diethion, diethylcarbamazine, diflovidazin, diflubenzuron, dimethoate, dimethyl disulphide, dimethylvinphos, dinotefuran, dioxathion, disulfoton, DNOC, d-trans allethrin, edifenphos, endosulfan, emamectin(-benzoate), empenthrin, EPN, epsiprantel, esfenvalerate, ethiofencarb, ethion, ethiprole, ethofenprox, ethoprop, ethoprophos, etoxazole, etrimphos, famphur, febantel, fenamiphos, fenbendazole, fenazaquin, fenbutatin oxide, fenitrothion, fenobucarb, fenothiocarb, fenoxycarb, fenpropathrin, fenpyrad, fenpyroximate, fenthion, fenvalerate, fipronil, flometoquin, flonicamid, fluacrypyrim, fluazuron, flubendazole, flubendiamide, flucycloxuron, flucythrinate, flufenoxuron, flufenprox, flufiprole, flumethrin, fluopyram, fluvalinate, flupyradifurone, fonophos, formetanate, formothion, fosthiazate, fubfenprox, furathiocarb, furfural, gamma-cyhalothrin, halfenprox, halofenozide, haloxon, heptafluthrin, heptenophos, Heterorhabtlitis bacteriophora, hexaflumuron, hexachlorophene, hexythiazox, hydramethylnon, hydroprene, imicyafos, imidacloprid, imiprothrin, indoxacarb, iprobenfos, isazophos, isofenphos, isoprocarb, isopropyl-O-salicylate, isoxathion, ivermectin, kadethrin, kinoprene, lambda-cyhalothrin, lepimectin, levamisole, lufenuron, malathion, mebendazole, mecarbam, mevinphos, mesulfenphos, metaflumizone, metaldehyde, metam sodium, metam potassium, methacrifos, methamidophos, methidathion, methiocarb, methomyl, methoxychlor, methoxyfenozide, methyl bromide, methyridine, metolcarb, mevinphos, milbemectin, momfluorothrin, monocrotophos, morantel, Myrothecium verrucaria strains naled, netobimin, niclopholan, niclosamide, nicotine, nitenpyram, nitroxynil, novaluron, noviflumuron, omethoate, oxamyl, oxfendazole, oxibendazole, oxyclozanide, oxydemethon-M, oxydeprofos, parathion A, parathion M, parbendazol, Pasteuria spp., permethrin, phenothiazine, phenothrin, phenthoate, phorate, phosalone, phosmet, phosphorodithioate, phosphamidon, phosphine, phoxim, piperonyl butoxide, pirimicarb, pirimiphos-methyl, prallethrin, praziquantel, profenofos, promecarb, propargite, propaphos, propetamphos, propoxur, prothiofos, prothoate, pyflubumide, pymetrozine, pyrachlophos, pyrantel, pyridalyl, pyridaphenthion, pyresmethrin, pyrethrum, pyridaben, pyrimidifen, pyriproxyfen, quinalphos, rafoxanide, resmethrin, rotenone, dioxabenzophos (salithion), Saponins of Quillaja saponaria, sebufos, silafluofen, spinosad, spinetoram, spirodiclofen, spiromesifen, spirotetratmat, Steinernema scapterisci strains, Steinemema feltiae, Steninernema kraussei, sulfotep, sulfoxaflor, sulfuramid, sulfuryl floride, sulprofos, tasmanone, tatar emetic, tau-fluvalinate, tebufenozide, tebufenpyrad, tebupirimiphos, teflubenzuron, tefluthrin, temephos, terbam, terbufos, tetradifon, tetra-chlorvinphos, tetramethrin, tetramisole, thenium, theta-cypermethrin, thiabendazole, thiacloprid, thiafenox, thiamethoxam, thiocyclam, thiodicarb, thiofanox, thiomethon, thionazin, thiophanate, thiosultap-sodium, thuringiensin, tolfenpyrad, tralomethrin, transfluthrin, triarathen, triazamate, triazophos, triazuron, trichlorfon, triclabendazole, triflumuron, trimethacarb, vamidothion, XMC, xylylcarb, zeta-cypermethrin, zinc phosphide.
Suitable examples of such additional herbicides are e.g.
1) from the group of the lipid biosynthesis inhibitors:
ACCase herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim and tralkoxydim; as well as non ACCase herbicides such as benfuresate, bensulide, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
2) from the group of the ALS inhibitors:
sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, mesosulfuron, metsulfuron, metsulfuron-methyl, nicosulfuron, orthosulfamuron, oxasulfuron, primisulfuron, primisulfuron-methyl, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron; imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam; pyrimdinylbenzoates such as bispyribac, bispyribac-sodium, pyribenzoxim, pyriftalid, pyriminobac, pyriminobac-methyl, pyrithiobac, pyrithiobac- sodium; and also sulfonylaminocarbonyl-triazolinone herbicides such as flucarbazone, flucarbazone-sodium, propoxycarbazone, propoxycarbazone-sodium, thiencarbazone and thiencarbazone-methyl.
5, 6, 7) from the group of the photosynthesis inhibitors:
photosystem II inhibitors, for example, including triazine, triazinone, triazolinone, pyridazinone herbicides such as ametryn, amicarbazone, atrazine, chloridazone, cyanazine, desmetryn, dimethametryn, hexazinone, metamitron, metribuzin, prometon, prometryn, propazine, simazine, simetryn, terbumeton, terbuthylazine, terbutryn and trietazine; urea herbicides such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thidiazuron; phenyl carbamates such as desmedipham, karbutilate, phenmedipham, phenmedipham-ethyl; nitrile herbicides such as bromofenoxim, bromoxynil and its salts and esters, ioxynil and its salts and esters; uracils such as bromacil, lenacil and terbacil, as well as bentazone and bentazone-sodium, pyridate, pyridafol, pentanochlor and propanil, and photosystems I inhibitors such as diquat, diquat-dibromide, paraquat, paraquat-dichloride and paraquat-dimetilsulfate.
14) from the group of the protoporphyrinogen oxidase inhibitors: acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, sulfentrazone, thidiazimin, saflufenacil;
11, 12, 13, 27) from the group of the bleacher herbicides:
PDS-inhibitors: beflubutamid, diflufenican, fluridone, fluorochloridone, flurtamone, norflurazon, picolinafen and 4-(3-trifluoromethylphenoxy)-2-(4-trifluoromethylphenyl)pyrimidine (CAS 180608-33-7), HPPD-inhibitors: benzobicyclon, benzocenap, isoxachlortole, isoxaflutole, mesotrione, pyrasulfotole, pyrazolynate, pyrazoxyfen, sulcotrione, tefuryltrione, tembotrione, topramezone, bicyclopyrone, bleachers, unknown target: aclonifen, amitrol and clomazone;
9) from the group of the EPSP synthase inhibitors:
glyphosate, glyphosate-isopropylammonium and glyphosate-trimesium (sulfosate), glyphosate-potassium; glyphosate-sodium, glyphosate-ammonium;
10) from the group of the glutamine synthase inhibitors:
bilanaphos (bialaphos), bilanaphos-sodium, glufosinate and glufosinate-ammonium;
18) from the group of the DHP synthase inhibitors:
asulam;
3, 23) from the group of the mitosis inhibitors:
compounds ofdinitroanilines, such as benfluralin, butralin, dinitramine, ethalfluralin, fluchloralin, oryzalin, pendimethalin, prodiamine and trifluralin; phosphoramidates, such as amiprophos, amiprophos-methyl and butamiphos; benzoic acids such as chlorthal, chlorthal-dimethyl; pyridines, such as dithiopyr and thiazopyr; benzamides, such as propyzamide and tebutam; carbmates: chlorpropham, propham and carbetamide.
15) from the group of the VLCFA inhibitors:
chloroacetamides such as acetochlor, alachlor, butachlor, dimethachlor, dimethanamid, dimethenamid-P, metazachlor, metolachlor, metolachlor-S, pethoxamid, pretilachlor, propachlor, propisochlor and thenylchlor;
oxyacetanilides, such as flufenacet and mefenacet; acetamides such as diphenamid, naproanilide and napropamide; tetrazolinones, such as fentrazamide, and
others, such as anilofos, cafenstrol, piperophos and pyroxasulfone.
20, 21, 26) from the group of the cellulose biosynthesis inhibitors:
chlorthiamid, dichlobenil, flupoxam and isoxaben;
24) from the group of the decoupler herbicides:
dinoseb, dinoterb and DNOC and its salts;
4) from the group of the auxin herbicides:
2,4-D and its salts and esters, 2,4-DB and its salts and esters, aminocyclopyrachlor and its salts and esters, aminopyralid and its salts such as aminopyralid-tris(2-hydroxypropyl)ammonium and its esters, benazolin, benazolin-ethyl, choramben and its salts and esters, clomeprop, clopyralid dicamba and its salts and esters, dichlorprop and its salts and esters, dichlorprop-P and its salts and esters, fluroxypyr, MCPA and its salts and esters, MCPA-thioethyl, MCPB and its salts and esters, mecoprop and its salts and esters, mecoprop-P and its salts and esters, picloram, quinclorac, quinmerac, triclopyr TBA (2,3,6) and its salts and esters;
19) from the group of the auxin transport inhibitors: diflufenzopyr, diflufenzopyr-sodium, naptalam and naptalam-sodium;
17, 25, 26) from the group of the other herbicides: bromobutide, chloroflurenol, chloroflurenol-methyl, cinmethylin, cumyluron, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, fenquinotrione, cyclopyrimorate, mevalocidin, fenoxasulfone, iofensulfuron, herbimycin, halauxifen, halauxifen-methyl, tiafenacil, and tridiphane.

Additional, safeners may also be added to the composition, suitable safeners are e.g.: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4,5]decane (AD 67, CAS nr. 71526-07-3), 4-carboxy-3,4-dihydro-2H-1-benzopyran-4-acetic acid (CL 304,415, CAS nr. 31541-57-8), 2,2-dichloro-N-[2-oxo-2-(2-propenylamino)ethyl]-N-2-propenylacetamide (DKA-24, CAS nr. 97454-00-7), 2-dichloromethyl-2-methyl-1,3-dioxolane (MG 191, CAS nr. 22052-63-7), 3-(dichloroacetyl)-2,2,5-trimethyl-1,3-oxazolidine (RD 29148, CAS nr. 52836-31-4), and 1-dichloroacetylazepane (TI-35, CAS nr. 64661-12-7).

In a preferred embodiment of the present invention one or more of the following fungicides, insecticides, nematicides, herbicides, fertilizer and/or inoculant is applied together with the flutriafol: imidacloprid, thiamethoxam, clothianidin, fipronil, atrazine, acetochlor (and respective safener), S-metolachlor (and respective safener), pethoxamid, sulfentrazone, mesotrione, dicamba, 2,4-D, glyphosate, pendimethalin, chloropicrin, fomesafen, saflufenacil, flufenacet, isoxaflutole (and respective safener), fludioxonil, ipconazole, tebuconazole, azoxystrobin, pyraclostrobin, mefenoxam, metalaxyl, thiophanate-methyl, thiram, fluazinam, abamectin, Bacillus spp., Pasteuria spp., fertilizer (10-34-0, 18-46-0, 7-21-7, 8-32-16) and inoculants (Bradyrhizobium spp., Rhizobium spp.).

In an embodiment of the present invention, flutriafol is the sole active fungicidal/pesticidal compound applied in the uses and methods herein described and/or present in the compositions as herein described and the use thereof. Accordingly, one aspect of the invention relates to the use of flutriafol for controlling or preventing pathogenic damage caused by the fungi Macrophomina phaseolina in a plant propagation material, a plant, part of a plant and/or plant organ that grow or grows at a later point in time, by applying a composition containing flutriafol (i.e. as the sole active fungicidal/pesticidal ingredient) on the plant, part of the plant, plant organ, plant propagation material or a surrounding area thereof; as well as another aspect of the invention that relates to a a method of controlling or preventing pathogenic damage caused by the fungi M. phaseolina in a plant propagation material, a plant, part of a plant and/or plant organ that grow or grows at a later point in time, which comprises applying on the plant, part of the plant, plant organ, plant propagation material or a surrounding area thereof a composition containing flutriafol (i.e. as the sole active fungicidal/pesticidal ingredient).

The composition comprising flutriafol may be applied as any type of agrochemically acceptable composition. The composition may be in a liquid form, such as an emulsifiable concentrate, a dispersion, a suspension concentrate, or aqueous emulsion; in a solid form, such as powders, dusts, pellets, or granules; or in a paste, wettable powder, or water-dispersible granules. Generally, it is preferred that when the composition is applied to the soil from which the seed grows, it is applied as liquid or solid composition. When the composition is applied to the seed, it is generally preferred that the composition be applied as a liquid composition. However, these preferences lie in the convenience of application, and no disadvantage is seen from applying the composition in another agrochemically acceptable form.

The composition will usually comprise 0.1 to 99%, preferably 0.1 to 95%, of flutriafol, and 1 to 99.9%, preferably 5 to 99.9%, of at least one solid or liquid carrier; usually they will contain 0.1 to 50%, preferably 0.1 to 20%, of surfactants (in each case percentages are by weight). Whereas commercial products will preferably be formulated as concentrates, the end user will normally employ dilute formulations having a substantially lower concentration of active ingredient. Particularly preferred formulations will be made up as follows: (throughout, percentages are by weight):

| | |
|---|---|
| Emulsifiable concentrates: | |
| Flutriafol: | 1 to 99%, preferably 60 to 90% |
| Surfactant: | 1 to 30%, preferably 1 to 20% |
| Solvent: | 1 to 80%, preferably 1 to 35% |
| Dusts: | |
| Flutriafol: | 0.1 to 90%, preferably 1 to 80% |
| Solid carrier: | 1 to 99.9%, preferably 15 to 90% |

| | |
|---|---|
| Suspension concentrates: | |
| Flutriafol: | 5 to 75%, preferably 10 to 50% |
| Water: | 24 to 94%, preferably 30 to 88% |
| Surfactant: | 1 to 40%, preferably 2 to 30% |
| Suspo-emulsion | |
| Flutriafol: | 1 to 99%, preferably 10 to 50% |
| Surfactant: | 1 to 30%, preferably 1 to 20% |
| Solvent: | 1 to 80%, preferably 1 to 35% |

Wettable powders:

| | |
|---|---|
| Flutriafol: | 0.1 to 90%, preferably 1 to 80% |
| Surfactant: | 1 to 50%, preferably 1 to 15% |
| Solid carrier: | 1 to 95%, preferably 15 to 90% |

Granulates:

| | |
|---|---|
| Flutriafol: | 0.1 to 90%, preferably 1 to 80% |
| Surfactant: | 1 to 50%, preferably 1 to 15% |
| Solid carrier: | 1 to 95%, preferably 15 to 90% |

Suspension composition for seed treatment:

| | |
|---|---|
| Flutriafol: | 0.1 to 90%, preferably 1 to 80% |
| Surfactant: | 1 to 40%, preferably 1 to 20% |
| Solvent: | 1 to 90%, preferably 1 to 50% |
| Colorants: | 0 to 40%, preferably 1 to 20% |
| Binder: | 0 to 60%, preferably 1 to 40% |

The compositions of the invention can for example be formulated as follows:
1. Products for dilution with water. For seed treatment purposes, such products may be applied to the seed diluted or undiluted.

### A) Water-Soluble Concentrates (SL, LS)

10 parts by weight of the active compound(s) are dissolved in 90 parts by weight of water or a water-soluble solvent. As an alternative, wetters or other auxiliaries are added. The active compound(s) dissolve(s) upon dilution with water, whereby a formulation with 10% (w/w) of active compound(s) is obtained.

### B) Dispersible Concentrates (DC)

parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

### C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD, FS)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

### F) Water-Dispersible Granules and Water-Soluble Granules (WG, SG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

### G) Water-Dispersible Powders and Water-Soluble Powders (WP, SP, SS, WS)

75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

H) Gel-Formulation (GF) In an agitated ball mill, 20 parts by weight of the active compound(s) are comminuted with addition of 10 parts by weight of dispersants, 1 part by weight of gelling agent wetters and 70 parts by weight of water or of an organic solvent to give a fine active compound) suspension. Dilution with water gives a stable suspension of the active compound(s), whereby a formulation with 20% (w/w) of active compound(s) is obtained.

### I) Capsule Supensions (CS)

28 parts of active compound(s), are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 3-10 microns.
2. Products to be applied undiluted. For seed treatment purposes, such products may be applied to the seed diluted or undiluted.

### J) Dustable Powders (DP, DS)

5 parts by weight of the active compound(s) are ground finely and mixed intimately with 95 parts by weight of finely divided kaolin. This gives a dustable product having 5% (w/w) of active compound(s).

### K) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

### L) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

Various types of oils, wetters, adjuvants, herbicides, insecticides, fungicides, other pesticides, or bactericides may be added to the active ingredients, if appropriate just immediately prior to use (tank mix). These agents usually are admixed with the agents according to the invention in a weight ratio of 1:20 to 20:1.

Each of the combinations of the invention can be formulated for a particular use. Preferably, each combination is formulated for protecting cultivated plants or their plant propagation materials. Accordingly, each combination of the invention can be applied to the plant in a conventional manner, such as an in-furrow application or foliar spray. Advantageously, each of the combinations are formulated for plant propagation material, such as seed, treatment applications for controlling or preventing damage caused by charcoal rot, which can particularly damage the plant in the early stages of its development.

To prepare emulsions, pastes or oil dispersions, the flutriafol composition can be homogenized in water or dissolved in an oil or solvent by means of wetting agents, adhesives, dispersants or emulsifiers, as known in the art. Concentrates comprising flutriafol, wetting agent, adhesive, dispersant or emulsifier, and possibly solvent or oil can also be prepared which are suitable for dilution with water. Powder, scattering, and dusting compositions may be prepared by mixing or joint grinding the flutriafol with a solid carrier.

Granules, for example coated, impregnated and homogeneous granules, may be prepared by binding flutriafol to solid carriers through known methods. Solid carriers include mineral earths, such as silica gel, silicic acids, silicates, talc, kaolin, limestone, lime, chalk, bole, loess, clay, dolomite, diatomaceous earth, calcium sulfate and magnesium sulfate, magnesium oxide, ground synthetic materials, fertilizers, such as ammonium sulfate, ammonium phosphate, ammonium nitrate, ureas and vegetable products, such as cereal flour, tree bark meal, wood meal and nutshell meal, corn grit, and cellulose powder.

The composition comprising flutriafol may be prepared in any known manner, such as with solvents, carriers, penetrating agents, soil surfactants, emulsifiers, dispersants, surface-active agents, or a combination thereof. Suitable solvents include aromatics (e.g. xylene), chlorinated aromatics (e.g. chloroben-zenes), paraffins (e.g. petroleum fractions), alcohols (e.g. methanol, butanol), ketones (e.g. cyclohexanone), amines (e.g., ethanolamine, dimethylformamide) and water. If water is used as a diluent, other organic solvents may be used as the solvents. Suitable carriers include ground natural minerals (e.g. kaolins, aluminas, talc, chalk) and ground synthetic minerals (e.g. highly disperse silica, silicates). Suitable emulsifiers include nonionic and anionic emulsifiers (e.g. polyoxyethylene fatty alcohol ethers, alkylsulfonates and arylsulfonates). Suitable dispersants include lignin-sulfite waste liquors and methylcellulose. Suitable surface-active agents include alkali metals, alkaline earth metals, ammonium salts of aromatic sulfonic acids, (e.g. lignosulfonic, phenolsulfonic, naphthalenesulfonic and dibutylnaphthalenesulfonic acid), fatty acids, alkyl- and alkylarylsulfonates, alkyl-, lauryl ether and fatty alcohol sulfates, salts of sulfated hexa-, hepta- and octadecanols, fatty alcohol glycol ethers, condensation products of sulfonated naphthalene and its derivatives with formaldehyde, condensation products of naphthalene or of the naphthalenesulfonic acids with phenol and formaldehyde, polyoxyethylene octylphenol ether, ethoxylated isooctyl-, octyl- or nonylphenol, alkylphenol or tributyl-phenylpolyglycol ethers, alkylaryl polyether alcohols, isotridecyl alcohol, fatty alcohol ethylene oxide condensates, ethoxylated castor oil, polyoxyethylene or polyoxypropylenealkyl ethers, lauryl alcohol polyglycol ether acetate, sorbitol esters, lignin-sulfite waste liquors, or methylcellulose. Suitable soil surfactants are such as tri-block copolymers, glucoethers (for example with the trade name Integrate 80), and non-ionic surfactants (for example with the trade name Integrate 20).

It may be useful to add one or more binders to the composition, particularly when the composition is applied in a seed treatment. Preferably, the binder is an adhesive polymer that may be natural or synthetic and does not produce a phytotoxic effect on the seed. Suitable binders include polyvinyl acetates; polyvinyl acetate copolymers; polyvinyl alcohols; polyvinyl alcohol copolymers; celluloses, including ethylcelluloses, methylcelluloses, hydroxymethylcelluloses, hydroxypropylcelluloses and carboxymethylcellulose; polyvinylpyrolidones; polysaccharides, including starch, modified starch, dextrins, maltodextrins, alginate and chitosans; fats; oils; proteins, including gelatin and zeins; gum arabics; shellacs; vinylidene chloride and vinylidene chloride copolymers; calcium lignosulfonates; acrylic copolymers; polyvinylacrylates; polyethylene oxide; acrylamide polymers and copolymers; polyhydroxyethyl acrylate, methylacrylamide monomers; and polychloroprene.

Optionally, also colorants can be included in the formulation. Suitable colorants or dyes for seed treatment formulations are Rhodamin B, C.I. pigment Red 112, C.I. Solvent Red 1 , pigment blue 15:4, pigment blue 15:3, pigment blue 15:2, pigment blue 15:1 , pigment blue 80, pigment yellow 1 , pigment yellow 13, pigment red 112, pigment red 48:2, pigment red 48:1 , pigment red 57:1, pigment red 53:1 , pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

### EXAMPLES

### Example 1

Inhibition of Macrophomina phaseolina (charcoal rot) was tested in the following example: The flutriafol composition used in the example was TOPGUARD (125 g/L flutriafol SC), a commercially available product.

Each pathogen was grown out on fresh potato dextrose agar (commercial PDA), assessed and used to seed 2× autoclaved rice for inoculums development. At 7-10 days, two infested rice grains with the pathogen was placed at equal distances on flutriafol-amended PDA and incubated at 27-29° C. Mycelial colony diameter from each rice grain was measured at 1, 3, 5 and 7 days from grain placement. The included tables and data sets illustrate the differences in mycelia growth in response to various concentrations of the fungicide.

TABLE 1
Inhibition of Macrophomina phaseolina by flutriafol at 1, 3, 5 and 7 days.

| | | Application | Dia (mm) | Dia (mm) | Dia (mm) | Dia (mm) |
|---|---|---|---|---|---|---|
| Treatment | Rate (ppm) | Frequency | 1 day | 3 days | 5 days | 7 days |
| 1. Untreated | n/a | | 28.2 | 40 | 40 | 40 |
| 2. flutriafol | 250 | 1x | 0 | 0 | 0 | 0 |
| 3. flutriafol | 100 | 1x | 0 | 0 | 0 | 0 |
| 4. flutriafol | 10 | 1x | 0 | 3.5 | 3.5 | 5.1 |
| 5. flutriafol | 1 | 1x | 13.9 | 38.6 | 40 | 40 |
| 6. flutriafol | 0.1 | 1x | 22.3 | 40 | 40 | 40 |
| 7. flutriafol | 0.01 | 1x | 25.5 | 40 | 40 | 40 |

### Example 2

The determination of the efficacy and selectivity of flutriafol when applied pre plant incorporated, and post plant drip to strawberry for control of charcoal rot was tested in the following example:

This experiment was conducted at a site with a history of charcoal rot.

Soil was a Pismo Loamy Sand with a pH of 5.4, Organic matter of 0.7% and a CEC of 9.9. This experiment was set up as a randomized complete block with four replications. Plots were a single row 3.33 feet wide and 35 feet long on raised plastic lined beds. Plot site was a conventional strawberry field and the trial was established May 4. Prior to planting the susceptible variety Portola, RHYME (a commercially available flutriafol 250 g/l SC formulation), was sprayed over the top of the bed with 0.26 lbs.ai per acre (291.4 g active ingredient per hectare; g/ha) at 50 gallons (189.27 litres) per acre of water volume (Application I) on May 28 and incorporated approximately 3 inches deep with a rototiller. After planting, RHYME was injected into a buried drip line at 0.26 lbs.ai/acre (Application Timing II) on June 11. Strawberry plants were planted in two lines 14 inches apart resulting in a plant density of 20,500 plants per acre. All plots received the same amount of water throughout the trial period via the buried drip lines. To assess efficacy, strawberries were harvested continuously from August 27^{th} to November 20^{th} resulting in a total of 19 harvest dates. All fruit were weighed, sized and evaluated for marketability. Infected plants per plot were assessed on October 7, October 22 and December 4.

The results demonstrate that flutriafol applied either surface incorporated or applied via buried drip significantly reduced charcoal rot. Similar levels of control were achieved by both application methods for RHYME, producing an increase in total yield over untreated in excess of 40%.

TABLE 2
INFECTED PLANTS

| | | | | | TOTAL |
|---|---|---|---|---|---|
| Trt | Treatment | Oct. 7, | Oct. 22, | Dec. 4, | IN- |
| No. | Name | 2013 | 2013 | 2013 | FECTED |
| 1 | Untreated check | 7.00 | 7.50 | 3.10 | 18.00 |
| 2 | Rhyme 0.26 lb. ai/a (I) | 2.70 | 5.30 | 0.70 | 10.00 |
| 3 | Rhyme 0.26 lb. ai/a (II) | 2.00 | 9.00 | 0.40 | 12.00 |

TABLE 3
TOTAL STRAWBERRY YIELD (WEIGHT PER MONTH kg)

| Trt | Treatment | YIELD/MONTH (KG) | | | | |
|---|---|---|---|---|---|---|
| No. | Name | AUGUST | SEPTEMBER | OCTOBER | NOVEMBER | TOTAL |
| 1 | Untreated check | 4.30 | 8.30 | 5.46 | 5.16 | 23.22 |
| 2 | Rhyme 0.26 lb. ai/a (I) | 5.85 | 12.95 | 8.02 | 7.10 | 33.92 |
| 3 | Rhyme 0.26 lb. | 5.01 | 15.97 | 6.59 | 5.76 | 33.33 |
| | ai/a (II) | | | | | |

We claim:

1. Use of flutriafol for controlling or preventing pathogenic damage caused by the fungi Macrophomina phaseolina in a plant propagation material, a plant, part of a plant and/or plant organ that grow or grows at a later point in time, by applying a composition comprising flutriafol on the plant, part of the plant, plant organ, plant propagation material or a surrounding area thereof.

2. The use according to claim 1, wherein the composition is applied to the soil from which the plant propagation material, a plant, part of a plant and/or plant organ grow or grows at a later point in time.

3. The use according to claim 1, wherein the composition is applied as foliar application.

4. The use according to claim 1, wherein the composition is applied to the plant propagation material.

5. The use according to claim 4, wherein the plant propagation material is a seed.

6. The use according to claim 2, wherein the composition is applied as in-furrow application to the soil from which the plant propagation material, a plant, part of a plant and/or plant organ grow or grows at a later point in time.

7. The use according to claim 6, wherein the plant propagation material is a seed.

8. The use according to claim 2, wherein the composition is applied in an amount ranging from about 25 to about 800 grams flutriafol per hectare.

9. The use according to claim 3, wherein the composition is applied in an amount ranging from about 25 to about 800 grams flutriafol per hectare of cultivation area.

10. The use according to claim 4, wherein the composition is applied in an amount ranging from about 1 to about 50 grams flutriafol per 100 kilograms of plant propagation material.

11. The use according to claim 1, wherein the composition further comprises one or more fertilizers.

12. The use according to claim 2, wherein the use further comprises applying one or more fertilizers and/or soil surfactants to the soil.

13. The use according to claim 1, wherein the composition further comprises one or more additional fungicides, herbicides, insecticides and/or nematicides.

14. The use according to claim 2, wherein the use further comprises applying one or more additional fungicides, insecticides and/or nematicides to the soil.

15. The use according to claim 1, wherein the plant is selected from the families of Brassicaceae, Cucurbitaceae, Leguminosae, Asteraceae, and Solanaceae and the crops sugar beets, cotton, pepper, tobacco and strawberry.

16. A composition comprising an effective amount of flutriafol for the use according to claim 1.

17. A method of controlling or preventing pathogenic damage caused by the fungi Macrophomina phaseolina in a plant propagation material, a plant, part of a plant and/or plant organ that grow or grows at a later point in time, which comprises applying on the plant, part of the plant, plant organ, plant propagation material or a surrounding area thereof a composition comprising flutriafol.

18. The method according to claim 17, wherein the composition is applied to the soil from which the plant propagation material, a plant, part of a plant and/or plant organ grow or grows at a later point in time.

19. The method according to claim 17, wherein the composition is applied as foliar application.

20. The method according to claim 17, wherein the composition is applied to the plant propagation material.

21. The method according to claim 20, wherein the plant propagation material is a seed.

22. The method according to claim 21, wherein the composition is applied as in-furrow application to the soil from which the plant propagation material, a plant, part of a plant and/or plant organ grow or grows at a later point in time.

23. The method according to claim 22, wherein the plant propagation material is a seed.

24. The method according to claim 18, wherein the composition is applied in an amount ranging from about 25 to about 800 grams flutriafol per hectare.

25. The method according to claim 19, wherein the composition is applied in an amount ranging from about 25 to about 800 grams flutriafol per hectare of cultivation area.

26. The method according to claim 20, wherein the composition is applied in an amount ranging from about 1 to about 50 grams flutriafol per 100 kilograms of plant propagation material.

27. The method according to claim 17, wherein the composition further comprises one or more fertilizers.

28. The method according to claim 18, wherein the method further comprises applying one or more fertilizers and/or soil surfactants to the soil.

29. The method according to claim 17, wherein the composition further comprises one or more additional fungicides, herbicides, insecticides and/or nematicides.

30. The method according to claim 18, wherein the method further comprises applying one or more additional fungicides, insecticides and/or nematicides to the soil.

31. The method according to claim 17, wherein the plant is selected from the families of Brassicaceae, Cucurbitaceae, Leguminosae, Asteraceae, and Solanaceae and the crops sugar beets, cotton, pepper, tobacco and strawberry.

32. A composition comprising an effective amount of flutriafol for use in a method according to claim 17.

33. A plant propagation material, a plant, part of a plant and/or plant organ that has been treated with flutriafol for the protection against the fungi Macrophomina phaseolina.
